(19) United States
(12) Patent Application Publication
(10) Pub. No.: US 2021/0271067 A1
(43) Pub. Date: Sep. 2, 2021

(54) OBSERVATION DEVICE, OBSERVATION METHOD, AND OBSERVATION SYSTEM

(71) Applicant: SONY CORPORATION, TOKYO (JP)

(72) Inventor: HIROKAZU TATSUTA, TOKYO (JP)

(21) Appl. No.: 17/274,694

(22) PCT Filed: Sep. 12, 2019
(86) PCT No.: PCT/JP2019/035992

§ 371 Date: Mar. 9, 2021

(30) Foreign Application Priority Data
Sep. 19, 2018 (JP) 2018-175058

(51) Int. Cl. G02B 21/36; G02B 21/06; G03H 1/00; G03H 1/04; H04N 5/225; G06T 5/00; G06T 5/50

(52) U.S. Cl. CPC G02B 21/367; G06T 2207/30004; G03H 1/0005; G03H 1/0443; G03H 1/0465; H04N 5/2256; G06T 5/006; G06T 5/50; G03H 2001/005; G03H 2001/0447; G03H 2001/0471; G03H 2210/55; G03H 2222/13; G03H 2222/12; G03H 2222/34; G03H 2223/15; G03H 2226/02; G03H 2226/11; G06T 2207/10056; G02B 21/06

(57) ABSTRACT

To obtain a more accurate image by improving a utilization efficiency of light energy while at the same time suppressing with a simpler method distortion that may occur in an inline hologram when a plurality of lights having different wavelengths are used, an observation device (1) according to the present disclosure includes a light source part (11) in which a plurality of light emitting diodes (101) having different light emission wavelengths with a length of each light emission point being smaller than 100λ (λ: light emission wavelength) are arranged such that a separation distance between the adjacent light emitting diodes is equal to or smaller than 100λ (λ: light emission wavelength); and an image sensor (13) installed so as to be opposed to the light source part with respect to an observation target object.

### TECHNICAL FIELD

The present disclosure relates to an observation device, an observation method, and an observation system.

### BACKGROUND ART

Hitherto, there has been proposed, as a small and low-cost microscope, a lensless microscope (also called “lensfree microscope”) that does not use an optical lens. Such a lensless microscope includes an image sensor and a coherent light source. In the lensless microscope, the coherent light source emits light, and a plurality of inline holograms, which are obtained by light diffracted by an observation target object such as a biomaterial and the light directly emitted by the coherent light source, are photographed by changing a condition such as a distance or a wavelength. After that, an amplified image and a phase image of the observation target object are reconstructed by light propagation calculation, and those images are provided to a user.

In such a lensless microscope, hitherto, a combination of a light emitting diode (LED) and a space aperture (e.g., pinhole or single-core optical fiber) has been used as the coherent light source. For example, NPL 1 described below discloses a lensless microscope using a coherent light source that is a combination of a light emitting diode and a pinhole.

### CITATION LIST

### Non Patent Literature

[NPL 1]
O. Mudanyali et al., Lab Chip, 2010, 10, pp. 1417-1428.

### SUMMARY

### Technical Problem

However, in the combination of an LED and a space aperture as disclosed in NPL 1 described above, a large proportion of light emitted by the LED cannot pass through the space aperture, leading to low energy utilization efficiency. As a result, the cost of a power source part or the like increases, and an original advantage of the lensless microscope cannot be obtained sufficiently.

Further, when an inline hologram is obtained by changing a separation distance between an image sensor and an observation target object, the lensless microscope as disclosed in NPL 1 described above performs control of changing a position of a stage at which the observation target object is placed, for example. However, when the accuracy of determining the position of the stage is low, a deviation in position of the stage causes an error, resulting in decrease in accuracy of the obtained image.

Further, when a plurality of lights having different wavelengths are used, a difference in angle of a ray becomes larger as a distance from a light emission point becomes larger, leading to such a concern that distortion occurs in the recorded inline hologram and reconstruction of the image has an error. In order to prevent distortion due to the difference in angle of a ray, first, it is conceivable to adopt a solution such as introduction of a plurality of lights by the same optical fiber and combination of the plurality of lights by using a dichroic mirror. However, when such a solution is used, the entire microscope becomes larger and the cost increases, which contradicts such an advantage that the lensless microscope is small and low in cost.

In view of the above-mentioned circumstances, the present disclosure proposes an observation device, an observation method, and an observation system, which are capable of obtaining a more accurate image by improving the utilization efficiency of light energy while at the same time suppressing with a simpler method distortion that may occur in an inline hologram when a plurality of lights having different wavelengths are used.

### Solution to Problem

According to the present disclosure, there is provided an observation device including a light source part in which a plurality of light emitting diodes having different light emission wavelengths with a length of each light emission point being smaller than 100λ (λ: light emission wavelength) are arranged such that a separation distance between the adjacent light emitting diodes is equal to or smaller than 100λ (λ: light emission wavelength); and an image sensor installed so as to be opposed to the light source part with respect to an observation target object.

Further, according to the present disclosure, there is provided an observation method including: applying light to an observation target object for each light emission wavelength by a light source part in which a plurality of light emitting diodes having different light emission wavelengths with a length of each light emission point being smaller than 100λ (λ: light emission wavelength) are arranged such that a separation distance between the adjacent light emitting diodes is equal to or smaller than 100λ (λ: light emission wavelength); and photographing an image of the observation target object for each light emission wavelength by an image sensor installed so as to be opposed to the light source part with respect to the observation target object.

Further, according to the present disclosure, there is provided an observation system including: a light source part in which a plurality of light emitting diodes having different light emission wavelengths with a length of each light emission point being smaller than 100λ (λ: light emission wavelength) are arranged such that a separation distance between the adjacent light emitting diodes is equal to or smaller than 100λ (λ: light emission wavelength); an image sensor installed so as to be opposed to the light source part with respect to an observation target object; and a calculation processing part for executing calculation processing of obtaining an image of the observation target object by using a photographed image for each light emission wavelength, which is generated by the image sensor.

According to the present disclosure, a light source part including a plurality of light emitting diodes installed so as to satisfy a predetermined condition applies light to an observation target object, and an inline hologram that is caused by the applied light is photographed by an image sensor installed so as to be opposed to the light source part with respect to the observation target object.

### Advantageous Effects of Invention

As described above, according to the present disclosure, it is possible to obtain a more accurate image by improving a utilization efficiency of light energy while at the same time suppressing with a simpler method distortion that may occur in an inline hologram when a plurality of lights having different wavelengths are used.

The above-mentioned effect is not necessarily given in a limited manner, and in addition to or instead of the above-mentioned effect, any effect shown in this specification or other effects that may be grasped based on this specification may be exhibited.

### BRIEF DESCRIPTION OF DRAWINGS

FIG. 1A is an explanatory diagram schematically illustrating an example of a configuration of an observation device according to an embodiment of the present disclosure.

FIG. 1B is an explanatory diagram schematically illustrating another example of the configuration of the observation device according to the embodiment.

FIG. 2A is an explanatory diagram schematically illustrating an example of a configuration of a light source part included in the observation device according to the embodiment.

FIG. 2B is an explanatory diagram schematically illustrating another example of the configuration of the light source part included in the observation device according to the embodiment.

FIG. 3 is a block diagram illustrating an example of a configuration of a calculation processing part included in the observation device according to the embodiment.

FIG. 4 is a block diagram illustrating an example of a configuration of an image calculation part included in the calculation processing part according to the embodiment.

FIG. 5 is a block diagram illustrating an example of a configuration of a preprocessing part included in the image calculation part according to the embodiment.

FIG. 6 is an explanatory diagram for describing reconstruction processing to be executed by a reconstruction processing part included in the image calculation part according to the embodiment.

FIG. 7 is a flow chart illustrating an example of a flow of the reconstruction processing according to the embodiment.

FIG. 8 is an explanatory diagram for describing the reconstruction processing to be executed by a reconstruction processing part included in the image calculation part according to the embodiment.

FIG. 9 is an explanatory diagram illustrating an example of a reconstructed image obtained by the observation device according to the embodiment.

FIG. 10 is a block diagram illustrating an example of a hardware configuration of the calculation processing part according to the embodiment.

FIG. 11 is a flow chart illustrating an example of a flow of an observation method according to the embodiment.

FIG. 12 is an explanatory diagram for describing an embodiment example.

FIG. 13 is an explanatory diagram for describing the embodiment example.

FIG. 14 is an explanatory diagram for describing the embodiment example.

### DESCRIPTION OF EMBODIMENTS

In the following, description is given in detail of a preferred embodiment of the present disclosure with reference to the attached drawings. In this specification and the drawings, components having substantially the same functional configuration are assigned with the same reference numeral, and redundant description thereof is omitted.

Description is given in the following order.

### 1. Embodiment

### 1.1 Observation Device

### 1.1.1 Overall Configuration of Observation Device and Hologram Acquisition Part

### 1.1.2 Calculation Processing Part

### 1.2 Observation Method

### 2. Embodiment Example

### Embodiment

### <Observation Device>

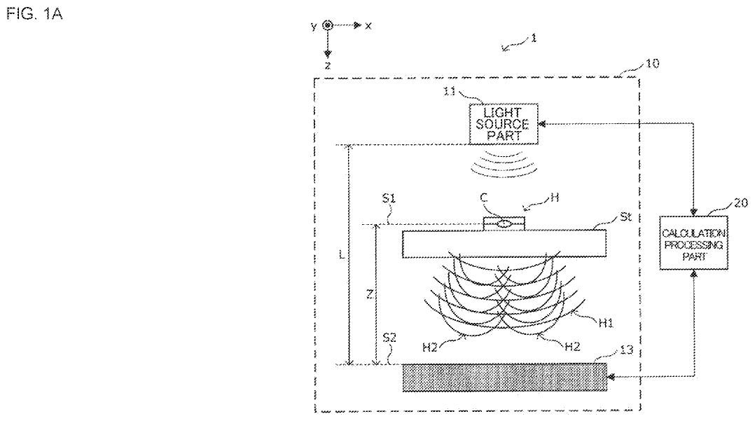

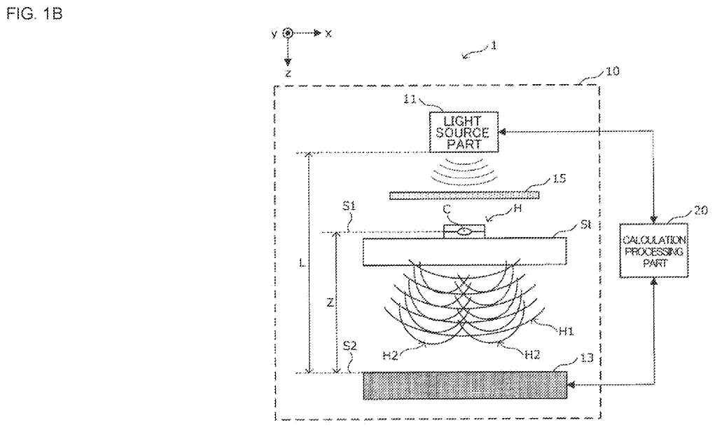

In the following, description is given in detail of an observation device according to an embodiment of the present disclosure with reference to FIG. 1A to FIG. 10.

### [Overall Configuration of Observation Device and Hologram Acquisition Part]

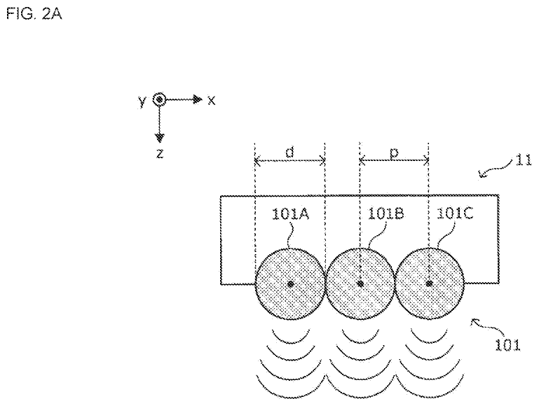

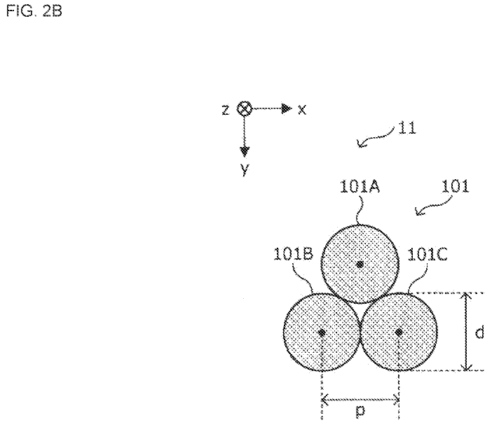

First, description is given in detail of an overall configuration of an observation device according to this embodiment and a hologram acquisition part included in the observation device according to this embodiment with reference to FIG. 1A to FIG. 2B.

FIG. 1A is an explanatory diagram schematically illustrating an example of a configuration of the observation device according to this embodiment, and FIG. 1B is an explanatory diagram schematically illustrating another example of the configuration of the observation device according to this embodiment. FIG. 2A is an explanatory diagram schematically illustrating an example of a configuration of a light source part included in the observation device according to this embodiment, and FIG. 2B is an explanatory diagram schematically illustrating another example of the configuration of the light source part included in the observation device according to this embodiment.

Overall Configuration of Observation Device

An observation device 1 according to this embodiment is a device to be used for observing a predetermined observation target object, and is a device for reconstructing an image of the observation target object by using a hologram (more specifically, inline hologram) image that occurs due to interference between light that has passed through the observation target object and light diffracted by the observation target object.

Regarding the observation target object focused on by the observation device 1 according to this embodiment, any object can be set as the observation target object as long as the object transmits light used for observation to some extent and enables interference between light that has passed through the observation target object and light diffracted by the observation target object. Such an observation target object may include, for example, a phase object for which light having a predetermined wavelength used for observation can be considered to be transparent to some extent, and such a phase object may include, for example, various kinds of biomaterials such as a cell of a living thing, biological tissue, a sperm cell, an egg cell, a fertilized egg, or a microbe.

In the following, description is given based on an exemplary case in which a biomaterial such as a cell, which is an example of the observation target object, exists in a predetermined sample holder.

As illustrated in FIG. 1A and FIG. 1B, the observation device 1 according to this embodiment for observing the above-mentioned observation target object includes a hologram acquisition part 10 for observing the observation target object and acquiring a hologram image of the observation target object, and a calculation processing part 20 for executing a series of calculation processing of reconstructing an image of the focused observation target object based on the obtained hologram image.

The hologram acquisition part 10 according to this embodiment acquires a hologram image of an observation target object C existing in a sample holder H placed at a predetermined position of an observation stage St under control by the calculation processing part 20 described later. The hologram image of the observation target object C acquired by the hologram acquisition part 10 is output to the calculation processing part 20 described later. A detailed configuration of the hologram acquisition part 10 having such a function is described later again.

The calculation processing part 20 integrally controls the processing of acquiring a hologram image by the hologram acquisition part 10. Further, the calculation processing part 20 executes a series of processing of reconstructing an image of the focused observation target object C by using the hologram image acquired by the hologram acquisition part 10. The image acquired by such a series of processing is presented to the user of the observation device 1 as an image that has photographed the focused observation target object C. A detailed configuration of the calculation processing part 20 having such a function is described later again.

In the above, the overall configuration of the observation device 1 according to this embodiment has been briefly described.

The observation device 1 according to this embodiment can also be realized as an observation system constructed by a hologram acquisition unit including the hologram acquisition part 10 having a configuration as described later in detail and a calculation processing unit including the calculation processing part 20 having a configuration as described later in detail.

Hologram Acquisition Part

Next, description is given in detail of the hologram acquisition part 10 in the observation device 1 according to this embodiment with reference to FIG. 1A to FIG. 2B. In the following, for the sake of convenience, a positional relationship among members constructing the hologram acquisition part 10 is described by using a coordinate system illustrated in FIG. 1A to FIG. 2B.

As illustrated in FIG. 1A, the hologram acquisition part 10 according to this embodiment includes a light source part 11 for applying illumination light to be used for acquiring a hologram image of the observation target object C, and an image sensor 13 for photographing a generated hologram image of the observation target object C. The operations of such the light source part 11 and the image sensor 13 are controlled by the calculation processing part 20. Further, the calculation processing part 20 may control a z-direction position of the observation stage St provided in the hologram acquisition part 10.

Illumination light from the light source part 11 is applied to the observation target object C supported in the sample holder H placed on the observation stage St. As schematically illustrated in FIG. 1A, the sample holder H includes a support surface S1 for supporting the observation target object C. The sample holder H is not particularly limited, and for example, is a prepared slide including a glass slide and a glass cover, which has a light transmission property.

Further, the observation stage St has a region having a light transmission property of transmitting illumination light of the light source part 11, and the sample holder H is placed on such a region. The region having a light transmission property provided in the observation stage St may be formed by a glass or the like, for example, or may be formed by an opening that passes through the upper surface and bottom surface of the observation stage St along the z-axis direction.

When the illumination light is applied to the observation target object C, such illumination light is divided into transmitted light H1 passing though the observation target object C and diffracted light H2 diffracted by the observation target object C. Such transmitted light H1 and diffracted light H2 interfere with each other, so that a hologram (inline hologram) image of the observation target object C is generated on a sensor surface S2 of the image sensor 13 installed so as to be opposed to the light source part 11 with respect to the observation target object C. In this description, in the observation device 1 according to this embodiment, Z represents the length of a separation distance between the support surface S1 and the sensor surface S2, and L represents the length of a separation distance between the light source part 11 (more specifically, emission port of illumination light) and the image sensor 13 (sensor surface S2). In this embodiment, the transmitted light H1 functions as reference light for generating a hologram of the observation target object C. The hologram image (hereinafter also referred to as “hologram”) of the observation target object C generated in this manner is output to the calculation processing part 20.

As illustrated in FIG. 1B, the hologram acquisition part 10 according to this embodiment is preferred to additionally include a bandpass filter 15 on an optical path between the light source part 11 and the observation target object C. Such a bandpass filter 15 is designed to include the wavelength of illumination light applied by the light source part 11 in a transmission wavelength band. It is possible to obtain a hologram with a higher contrast and quality by additionally providing such a bandpass filter 15 and enabling improvement in spatial coherence and temporal coherence of illumination light applied by the light source part 11.

In this manner, the hologram acquisition part 10 according to this embodiment does not use a space aperture unlike a conventional lensless microscope, and thus can use energy of illumination light applied by the light source part 11 more efficiently.

In the observation device 1 according to this embodiment, the light source part 11 applies a plurality of illumination lights having different wavelengths. Such a light source part 11 includes a plurality of light emitting diodes (LED) having different light emission wavelengths and enabling application of partially coherent light in order to apply illumination lights having different wavelengths. Thus, the above-mentioned bandpass filter 15 functions as a multi-bandpass filter designed to have one or a plurality of transmission wavelength bands so as to handle the light emission wavelength of each LED.

The light emission wavelength of each LED constructing the light source part 11 is not particularly limited as long as the LEDs have different light emission wavelengths, and it is possible to use light having any light emission peak wavelength belonging to any wavelength band. The light emission wavelength (light emission peak wavelength) of each LED may belong to an ultraviolet light band, a visible light band, or a near-infrared band, for example. Further, each LED constructing the light source part 11 to be used may be any publicly known LED as long as the LED satisfies a condition on two types of lengths described later in detail.

In the light source part 11 according to this embodiment, the number of LEDs is not particularly limited as long as the number is equal to or larger than two. The size of the light source part 11 becomes larger as the number of LEDs becomes larger, and thus the light source part 11 is preferred to include three LEDs having different light emission wavelengths in consideration of reduction in size of the observation device 1. In the following, description is given based on an exemplary case in which the light source part 11 includes three LEDs having different light emission wavelengths.

In the light source part 11 according to this embodiment, the length of a light emission point of each LED constructing the light source part 11 is smaller than 100λ (λ: light emission wavelength). Further, each LED constructing the light source part 11 is arranged such that a separation distance between adjacent LEDs is equal to or smaller than 100λ (λ: light emission wavelength). At this time, as the light emission wavelength a serving as a reference for the length of a light emission point and the separation distance between LEDs, a shortest peak wavelength is used among peak wavelengths of light emitted by each LED included in the light source part 11.

The LEDs are adjacent to one another such that the length of each light emission point is smaller than 100λ and the separation distance between adjacent LEDs is equal to or smaller than 100λ, which enables the observation device 1 according to this embodiment to obtain a more accurate image by enabling cancellation of distortion between holograms due to deviation in light emission point of the LED through use of simple shift correction described later in detail. A group of LEDs satisfying the above-mentioned two conditions are hereinafter also referred to as “micro LED”. When the length of each light emission point is equal to or larger than 100λ, or the separation distance between adjacent LEDs is larger than 100λ, deviation in light emission point between LEDs becomes significant, and even when shift correction as described later in detail is performed, distortion between holograms cannot be cancelled. The length of each light emission point is preferably smaller than 80λ, and more preferably smaller than 40λ. Further, the separation distance between adjacent LEDs is preferably equal to or smaller than 80λ, and more preferably equal to or smaller than 60λ. The length of each light emission point and the separation distance between adjacent LEDs are desired to be smaller without limitation, and a lower limit value is not particularly limited.

Further, the length of the above-mentioned separation distance is more preferably equal to or smaller than five times the length of the above-mentioned light emission point. The length of the light emission point and the length of the separation distance have the above-mentioned relationship, which enables distortion between holograms to be cancelled more reliably and an image with a further higher quality to be obtained. The length of the above-mentioned separation distance is more preferably equal to or smaller than one and a half times the length of the above-mentioned light emission point.

For example, as illustrated in FIG. 2A, three LEDs 101A, 101B, and 101C (in the following, a plurality of LEDs may be collectively referred to as “light emitting diode 101” or “LED 101”) having three different light emission wavelengths may be arranged in one row in the light source part 11 according to this embodiment. In the example illustrated in FIG. 2A, the three LEDs 101A, 101B, and 101C are arranged in one row along an x-axis direction. Further, in FIG. 2A, the length indicated by d corresponds to the length of the light emission point of the LED 101, and the length of a distance between centers indicated by p corresponds to the length of the separation distance (in other words, pitch between adjacent LEDs 101) between the adjacent LEDs 101.

Further, for example, as illustrated in FIG. 2B, the three LEDs 101A, 101B, and 101C having different light emission wavelengths may be arranged in a triangle in the light source part 11 according to this embodiment. In the example illustrated in FIG. BA, a mode in a case where the three LEDs 101A, 101B, and 101C of the light source part 11 are viewed from the above along the z-axis is schematically illustrated, and the three LEDs 101A, 101B, and 101C are arranged such that a contour of a set of the three LEDs 101A, 101B, and 101C forms a triangle on an xy-plane. Also in the example illustrated in FIG. 2B, the length indicated by d corresponds to the length of the light emission point of the LED 101, and the length of the distance between centers indicated by p corresponds to the length of the separation distance between the adjacent LEDs 101.

In the light source part 11 illustrated in FIG. 2A and FIG. 2B, the light emission peak wavelength of each LED can be selected from a combination of 460 nm, 520 nm, and 630 nm, for example. Such a combination of light emission peak wavelengths is only one example, and any combination of light emission peak wavelengths can be adopted.

The light source part 11 having the above-mentioned configuration sequentially turns on each LED 101 and causes a hologram at each light emission wavelength under control by the calculation processing part 20.

Referring back to FIG. 1A and FIG. 1B, description is given of the image sensor 13 in the hologram acquisition part 10 according to this embodiment.

The image sensor 13 according to this embodiment records a hologram (inline hologram) of the observation target object C, which has occurred on the sensor surface S2 illustrated in FIG. 1A and FIG. 1B, in synchronization with the lighting state of each LED under control by the calculation processing part 20. As a result, the image sensor 13 generates the same number of pieces of image data (namely, hologram image data) on the hologram as the number of light emission wavelengths of the LED in the light source part 11. Such an image sensor 13 is not particularly limited as long as the image sensor 13 has sensitivity to the wavelength band of illumination light emitted by various kinds of LEDs used as the light source part 11, and various kinds of publicly known image sensors can be used as the image sensor 13. Such an image sensor may include, for example, a charged-coupled device (CCD) sensor or a complementary metal-oxide-semiconductor (CMOS) sensor. Those image sensors may be a monochrome sensor or a color sensor. Further, pixel sizes of those image sensors may be selected appropriately depending on the length of the light emission point of the LED 101 used as the light source part 11, for example, and are not particularly limited. For example, the pixel sizes are preferred to be about 100 μm.

The hologram acquisition part 10 according to this embodiment records only the light intensity distribution (square value of amplitude) of a hologram on the sensor surface S2, and does not record the distribution of phases. However, the calculation processing part 20 executes a series of image reconstruction processing as described later in detail to reproduce the distribution of phases of the hologram.

Further, the bandpass filter 15 according to this embodiment as illustrated in FIG. 1B is installed on the optical path between the light source part 11 and the observation target object C, and transmits only the illumination light applied by the light source part 11 toward the observation target object C. Such a bandpass filter 15 is provided to enable further improvement in spatial coherence and temporal coherence of illumination light, and achieve more efficient partially coherent illumination. Such a bandpass filter 15 is not particularly limited as long as the bandpass filter 15 is designed such that the transmission wavelength band corresponds to the light emission peak wavelength of the LED provided in the light source part 11, and various kinds of publicly known bandpass filters can be used appropriately.

As described above, the hologram acquisition part 10 according to this embodiment can acquire a more accurate hologram image of the observation target object with an extremely small number of parts by including an image sensor and an LED for which the length and pitch of the light emission point satisfy a specific condition, and further including a bandpass filter as necessary.

In the above, the configuration of the hologram acquisition part 10 in the observation device 1 according to this embodiment has been described in detail with reference to FIG. 1A to FIG. 2B.

### [Calculation Processing Part]

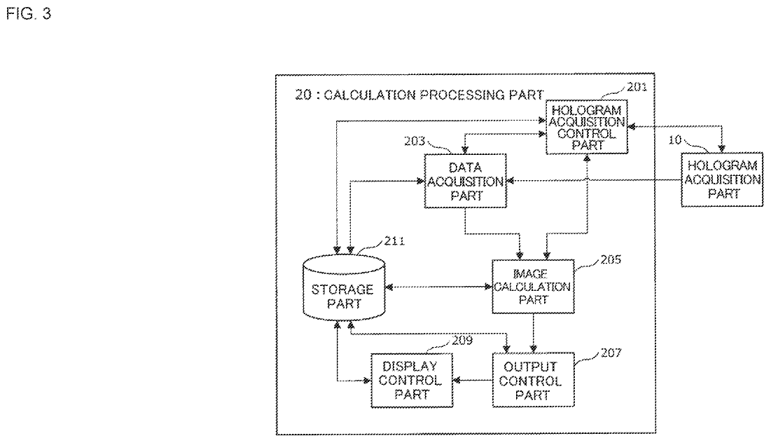

Next, description is given in detail of the calculation processing part included in the observation device 1 according to this embodiment with reference to FIG. 3 to FIG. 10.

The calculation processing part 20 according to this embodiment integrally controls the activation state of the hologram acquisition part 10 included in the observation device 1 according to this embodiment. Further, the calculation processing part 20 uses a hologram image of the observation target object C acquired by the hologram acquisition part 10 to execute a series of processing of reconstructing an image of the observation target object C based on such a hologram image.

Overall Configuration of Calculation Processing Part

As schematically illustrated in FIG. 3, such a calculation processing part 20 includes a hologram acquisition control part 201, a data acquisition part 203, an image calculation part 205, an output control part 207, a display control part 209, and a storage part 211.

The hologram acquisition control part 201 is realized by, for example, a central processing unit (CPU), a read only memory (ROM), a random access memory (RAM), an input device, and a communication device. The hologram acquisition control part 201 integrally controls the activation state of the hologram acquisition part 10 based on observation condition information on various kinds of observation conditions of the hologram acquisition part 10 input through a user operation. Specifically, the hologram acquisition control part 201 controls the plurality of LEDs 101 provided in the light source part 11 of the hologram acquisition part 10, and controls the lighting state of each LED 101. Further, the hologram acquisition control part 201 controls the activation state of the image sensor 13 to generate a hologram (inline hologram) image of the observation target object C for each light emission wavelength on the sensor surface S2 of the image sensor 13 while at the same time synchronizing the activation state with the lighting state of each LED 101.

Further, the hologram acquisition control part 201 can also control the position of the observation stage St provided in the hologram acquisition part 10 along the z-axis direction. The hologram acquisition control part 201 may output the observation condition information and various kinds of information on the activation state of the hologram acquisition part 10 to the data acquisition part 203 and the image calculation part 205, and cause the data acquisition part 203 and the image calculation part 205 to use those pieces of information for various kinds of processing.

The data acquisition part 203 is realized by, for example, a CPU, a ROM, a RAM, and a communication device. The data acquisition part 203 acquires, from the hologram acquisition part 10, image data on the hologram image of the observation target object C for each light emission wavelength, which has been acquired by the hologram acquisition part 10 under control by the hologram acquisition control part 201. When the data acquisition part 203 has acquired image data from the hologram acquisition part 10, the data acquisition part 203 outputs the acquired image data on the hologram image to the image calculation part 205 described later. Further, the data acquisition part 203 may record the acquired image data on the hologram image into the storage part 211 described later as history information in association with time information on, for example, a date and time at which such image data has been acquired.

The image calculation part 205 is realized by, for example, a CPU, a ROM, and a RAM. The image calculation part 205 uses the image data on the hologram image of the observation target object C for each light emission wavelength, which is output from the data acquisition part 203, to execute a series of image calculation processing of reconstructing an image of the observation target object C. A detailed configuration of such an image calculation part 205 and details of the image calculation processing executed by the image calculation part 205 are described later again.

The output control part 207 is realized by, for example, a CPU, a ROM, a RAM, an output device, and a communication device. The output control part 207 controls output of image data on the image of the observation target object C calculated by the image calculation part 205. For example, the output control part 207 may cause the output device such as a printer to output the image data on the observation target object C calculated by the image calculation part 205 for provision to the user as a paper medium, or may cause various kinds of recording media to output the image data. Further, the output control part 207 may cause various kinds of information processing devices such as an externally provided computer, server, and process computer to output the image data on the observation target object C calculated by the image calculation part 205 so as to share the image data. Further, the output control part 207 may cause a display device such as various kinds of displays included in the observation device 1 or a display device such as various kinds of displays provided outside of the observation device 1 to output the image data on the observation target object C calculated by the image calculation part 205 in cooperation with the display control part 209 described later.

The display control part 209 is realized by, for example, a CPU, a ROM, a RAM, an output device, and a communication device. The display control part 209 performs display control when the image of the observation target object C calculated by the image calculation part 205 or various kinds of information associated with the image are displayed on an output device such as a display included in the calculation processing part 20 or an output device provided outside of the calculation processing part 20, for example. In this manner, the user of the observation device 1 can grasp various kinds of information on the focused observation target object on the spot.

The storage part 211 is realized by, for example, a RAM or a storage device included in the calculation processing part 20. The storage part 211 stores, for example, various kinds of databases or software programs to be used when the hologram acquisition control part 201 or the image calculation part 205 executes various kinds of processing. Further, the storage part 211 appropriately records, for example, various kinds of settings information on, for example, the processing of controlling the hologram acquisition part 10 executed by the hologram acquisition control part 201 or various kinds of image processing executed by the image calculation part 205, or progresses of the processing or various kinds of parameters that are required to be stored when the calculation processing part 20 according to this embodiment executes some processing. The hologram acquisition control part 201, the data acquisition part 203, the image calculation part 205, the output control part 207, the display control part 209, or the like can freely execute processing of reading/writing data from/to the storage part 211.

In the above, the overall configuration of the calculation processing part 20 included in the observation device 1 according to this embodiment has been described with reference to FIG. 3.

Configuration of Image Calculation Part

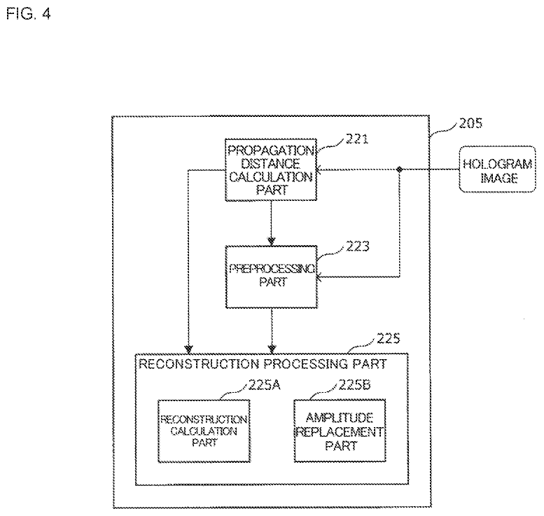

The image calculation part 205 uses image data on the hologram image of the observation target object C for each light emission wavelength to execute a series of image calculation processing of reconstructing an image of the observation target object C. As schematically illustrated in FIG. 4, such an image calculation part 205 includes a propagation distance calculation part 221, a preprocessing part 223, and a reconstruction processing part 225 including a reconstruction calculation part 225A and an amplitude replacement part 225B. In the following description, for the sake of convenience, it is assumed that z=0 represents the position of the support surface S1 and z=Z represents the position of the sensor surface S2 as the z-axis coordinates illustrated in FIG. 1A and FIG. 1B. Further, it is assumed that the light source part 11 applies illumination lights having light emission peak wavelengths λ₁, λ₂, λ₃, and the image sensor 13 acquires hologram images g_{λ1}, g_{λ2}, g_{λ3} (more specifically, image relating to amplitude strength of hologram).

The propagation distance calculation part 221 is realized by, for example, a CPU, a ROM, and a RAM. The propagation distance calculation part 221 uses a digital focus technology (digital focusing) utilizing Rayleigh-Sommerfeld diffraction integral to calculate a specific value of a separation distance Z (separation distance between support surface S1 and sensor surface S2) illustrated in FIG. 1A and FIG. 1B as a propagation distance Z. Digital focusing herein refers to a technique of determining the focus position of each hologram image g_{λ1}, g_{λ2}, g_{λ3} by adjusting the propagation distance Z (separation distance Z illustrated in FIG. 1A and FIG. 1B) between the support surface S1 and the sensor surface S2.

In this case, the hologram acquisition control part 201 acquires, in advance, a focus image a(x, y, z) at each light emission wavelength while at the same time controlling the hologram acquisition part 10 to change the z-coordinate position of the observation stage St. In this case, a(x, y, 0) corresponds to a hologram image g_{λn} generated on the sensor surface S2.

The propagation distance calculation part 221 first uses a plurality of focus images having different z-coordinate positions to calculate a difference value f(z+Δz/Z) of luminance between focus images represented by the following expression (101). As can be understood from the following expression (101), a total sum of luminance differences at respective points forming image data is calculated for the entire image. Such a total sum can be used to obtain an output curve representing how the luminance value has changed along the z-axis direction (optical-path direction).

$$\begin{matrix}[ Math . 1 ] & \\ f ( z + \frac{Δ z}{2} ) = {\sum }_{x} {\sum }_{y} \{ a ( x , y , z + Δ z ) - a ( x , y , z ) \} & expression ( 101 )\end{matrix}$$

Next, the propagation distance calculation part 221 calculates a differential value f(z) of f(z+Δz/Z) calculated based on the expression (101) with respect to a variable z. Then, a z-position that gives the peak of the obtained differential value f(z) is a focus position of the focused hologram image g. Such a focus position is set as a specific value of the separation distance Z illustrated in FIG. 1A and FIG. 1B, namely, the propagation distance.

The propagation distance calculation part 221 outputs information on the propagation distance Z obtained in this manner to the preprocessing part 223 and the reconstruction processing part 225 at a subsequent stage.

In the above, the case of the propagation distance calculation part 221 calculating the separation distance Z by using the digital focus technology utilizing Rayleigh-Sommerfeld diffraction integral has been described. However, the propagation distance calculation part 221 may calculate the propagation distance Z based on the mechanical accuracy (accuracy of positioning observation stage St) of the hologram acquisition part 10.

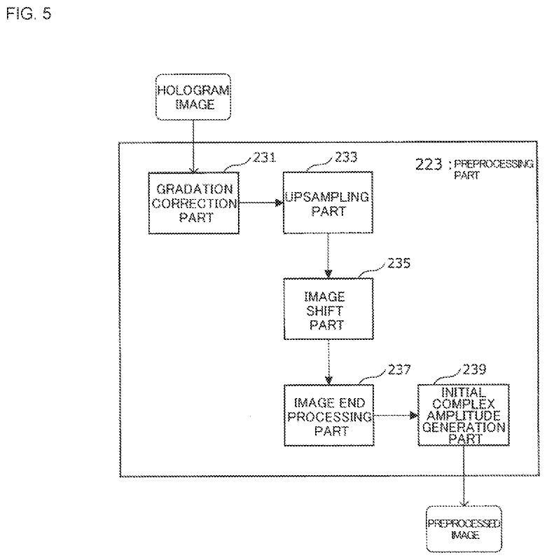

The preprocessing part 223 is realized by, for example, a CPU, a ROM, and a RAM. The preprocessing part 223 executes, for the photographed image (namely, hologram image gin) for each light emission wavelength, preprocessing including at least shift correction of the image that depends on a positional relationship among the plurality of light emitting diodes. As illustrated in FIG. 5, this preprocessing part 223 includes a gradation correction part 231, an upsampling part 233, an image shift part 235, an image end processing part 237, and an initial complex amplitude generation part 239.

The gradation correction part 231 is realized by, for example, a CPU, a ROM, and a RAM. The gradation correction part 231 performs gradation correction (e.g., dark level correction and inverse gamma correction) of the image sensor 13, and executes processing of returning an image signal based on the hologram images g_{λ1}, g_{λ2}, g_{λ3} output from the data acquisition part 203 to a linear state. Specific details of the processing of gradation correction to be executed are not particularly limited, and various kinds of publicly known details of processing can be appropriately used. The gradation correction part 231 outputs the hologram images g_{λ1}, g_{λ2}, g_{λ3} after gradation correction to the upsampling part 233 at a subsequent stage.

The upsampling part 233 is realized by, for example, a CPU, a ROM, and a RAM. The upsampling part 233 upsamples image signals of the hologram images g_{λ1}, g_{λ2}, g_{λ3} after gradation correction. The hologram acquisition part 10 according to this embodiment is constructed as a so-called lensless microscope, and thus the resolution may exceed a Nyquist frequency of the image sensor 13. Thus, in order to exhibit the maximum performance, the hologram images g_{λ1}, g_{λ2}, g_{λ3} after gradation correction are subjected to upsampling processing. The upsampling processing to be executed specifically is not particularly limited, and various kinds of publicly known upsampling processing can be used appropriately.

The image shift part 235 is realized by, for example, a CPU, a ROM, and a RAM. The image shift part 235 executes, for the hologram image (more specifically, hologram image subjected to the above-mentioned gradation correction processing and upsampling processing) for each light emission wavelength, which has been acquired by the hologram acquisition part 10, shift correction of the image that depends on the positional relationship among the plurality of light emitting diodes.

More specifically, the image shift part 235 executes shift correction so as to cancel a deviation in position of the hologram image due to the position at which each LED 101 is provided. Such shift correction is performed by shifting spatial coordinates (x, y, z) defining the pixel position of the hologram image in a predetermined direction.

Specifically, the image shift part 235 selects one LED 101 serving as a reference from among the plurality of LEDs 101, and shifts the spatial coordinates (x, y, z) of hologram images photographed by using remaining LEDs 101 other than the reference LED among the plurality of LEDs 101 in a direction of a hologram image photographed by using the reference LED. The movement amount (shift amount) at the time of performing such shifting is determined based on the amount of positional deviation between focused LEDs 101 and a magnification determined based on a distance (L−Z) between the light source part 11 and the support surface S1 and a distance Z between the support surface S1 and the sensor surface S2. The distance Z is the propagation distance calculated by the propagation distance calculation part 221.

For example, as schematically illustrated in FIG. 2A, a case in which the three LEDs 101A, 101B, and 101C having different light emission wavelengths are arranged in the light source part 11 in one row along the x-axis direction is considered. In this case, when the LED 101B positioned at the center is set as the reference LED, the remaining LEDs 101 and 101C are present at positions deviating by −p in a negative direction of the x-axis and by +p in a position direction of the x-axis with respect to the reference LED 101B, respectively. The deviation of the length |p| at the position of the light source part 11 is magnified by {Z/(L−Z)} times on the sensor surface S2. Thus, when the image shift part 235 performs shift correction of the hologram image photographed by using the LED 101A, the image shift part 235 corrects spatial coordinates (x, y, z) defining the pixel position of such a hologram image to (x+δ, y, z) by the correction amount calculated by the following expression (111). Similarly, when the image shift part 235 performs shift correction of the hologram image photographed by using the LED 101C, the image shift part 235 corrects the spatial coordinates (x, y, z) defining the pixel position of such a hologram image to (x−δ, y, z) by the correction amount calculated by the following expression (111). With such shift processing, the positional deviation between hologram images due to the position at which the LED 101 is provided is cancelled.

$$\begin{matrix}[ Math . 2 ] & \\ δ = \frac{p Z}{L - Z} & expression ( 111 )\end{matrix}$$

In the expression (111) given above, δ represents a correction amount, L represents a distance between the light source part and the image sensor, Z represents a distance between the observation target object and the image sensor, and p represents a distance between the light emitting diodes.

In the above description, the LED 101B positioned at the center is set as a reference in FIG. 2A, but the LED 101A or the LED 101C can also be set as a reference. Also in this case, similarly to the above description, the spatial coordinates (x, y, z) defining the pixel position forming the hologram image may be shifted in the direction of the reference LED based on the distance between LEDs at the position of the light source part 11, and the magnification {Z/(L−Z)} defined by a positional relationship among the light source part 11, the observation target object C, and the image sensor 13.

Further, for example, as illustrated in FIG. 2B, a case in which the three LEDs 101 having different light emission wavelengths are arranged in a triangle in the light source part 11. In this case, when the LED 101A positioned at the center is set as the reference LED, the spatial coordinates (x, y, z) of hologram images obtained by using the remaining LEDs 101B and 101C may be shifted in the x-axis direction and the y-axis direction, respectively.

For example, when the LED 101A and the LED 101B are focused on, the amount of deviation between the LED 101A and the LED 101B in the x-axis direction is (p/2), and the amount of deviation in the y-axis direction is {(3^{0.5}/2)×p}. Thus, the image shift part 235 corrects the spatial coordinates (x, y, z) defining the pixel position of the hologram image obtained by using the LED 101B to (x+(p/2)x{Z/(L−Z)}, y−{(3^{0.5}/2)×p}x{Z/(L−Z)}, z). Similarly, when the LED 101A and the LED 101C are focused on, the image shift part 235 corrects the spatial coordinates (x, y, z) defining the pixel position of the hologram image obtained by using the LED 101B to (x−(p/2)x{Z/(L−Z)}, y−{(3^{0.5}/2)×p}x{Z/(L−Z)}, z).

Also in the example illustrated in FIG. 2B, the LED 101B or the LED 101C can be set as a reference. Also, in this case, similarly to the above description, the spatial coordinates (x, y, z) defining the pixel position forming the hologram image may be shifted in the direction of the reference LED based on the distance between LEDs at the position of the light source part 11, and the magnification {Z/(L−Z)} defined by the positional relationship among the light source part 11, the observation target object C, and the image sensor 13.

In shift correction as described above, the shift amount is calculated in a length unit system of parameters p, Z, L. Thus, the image shift part 235 is preferred to ultimately convert the correction amount to an amount in a pixel unit system based on the pixel pitch of the image sensor 13.

Shift correction as described above can be realized only when the light source part 11 according to this embodiment uses a micro LED in a state in which two conditions on the length as described above are satisfied. In a case where the two conditions on the length as described above are not satisfied in the light source part 11, the positional deviation between hologram images cannot be cancelled even when the spatial coordinates defining the pixel position of the hologram image are shifted based on the idea as described above.

After the image shift part 235 has executes shift correction of the hologram image subjected to gradation correction and upsampling processing as described above, the image shift part 235 outputs the hologram image after shift correction to the image end processing part 237 at a subsequent stage.

The above description has been given with a focus on the case in which the position of the reference LED 101 is selected and the spatial coordinates defining the pixel position forming the hologram image are shifted to such a position of the LED 101. However, the image shift part 235 may not select the position of the reference LED 101, but select a reference position such as the center of gravity of positions at which the plurality of LEDs 101 are arranged, and shift the spatial coordinates defining the pixel position forming the hologram image to such a position, for example.

The image end processing part 237 is realized by, for example, a CPU, a ROM, and a RAM. The image end processing part 237 executes processing for an image end of the hologram images g_{λ1}, g_{λ2}, g_{λ3} after shifting of the image. A boundary condition specifying the pixel value=0 outside the input value is applied to the image end, which is similar to a condition of existence of a knife edge on the image end. As a result, diffracted light occurs and causes a new artifact. In view of this, the image end processing part 237 prepares pixels twice as much as those of an original image in each of the vertical and horizontal directions, and executes processing of embedding a luminance value at the edge portion in the outside of the original image arranged at the center. In this manner, it is possible to prevent a diffraction fringe that occurs due to the processing of the image end from influencing the range of the original image. After the image end processing part 237 has executed the processing as described above, the image end processing part 237 outputs the hologram images g_{λ1}, g_{λ2}, g_{λ3} after execution of the processing to the initial complex amplitude generation part 239 at a subsequent stage.

The initial complex amplitude generation part 239 is realized by, for example, a CPU, a ROM, and a RAM. The initial complex amplitude generation part 239 sets, for the hologram image g_{λ1}, g_{λ2}, g_{λ3}, a square root of the pixel value (luminance value) as the real part of a complex amplitude of the hologram and 0 as the imaginary part thereof to obtain an initial value of the complex amplitude. In this manner, the initial complex amplitudes of the hologram image g_{λ1}, g_{λ2}, g_{λ3} having only the amplitude component are generated. The above-mentioned pixel value (luminance value) is a pixel value (luminance value) subjected to various kinds of preprocessing as described above. In this manner, a preprocessed image to be subjected to a series of reconstruction processing by the reconstruction processing part 225 is generated.

After the initial complex amplitude generation part 239 has generated the preprocessed image as described above, the initial complex amplitude generation part 239 outputs the generated preprocessed image to the reconstruction processing part 225.

In the above, the configuration of the preprocessing part 223 according to this embodiment has been described with reference to FIG. 5. Next, referring back to FIG. 4, description is given in detail of the reconstruction processing part 225 included in the image calculation part 205 according to this embodiment.

As illustrated in FIG. 4, the reconstruction processing part 225 includes the reconstruction calculation part 225A and the amplitude replacement part 225B. The reconstruction processing part 225 repeats propagation between planes of the sensor surface S2 and the support surface S1 under a constraint condition on the hologram image (more specifically, preprocessed image) output from the preprocessing part 223, to reproduce a phase component of the complex amplitude distribution for the hologram, which is lost on the sensor surface S2.

Specifically, the reconstruction processing part 225 reproduces the lost phase component by propagating the hologram image through optical wave propagation calculation by the reconstruction calculation part 225A and repeatedly replacing those amplitude components by the amplitude replacement part 225B. At this time, the reconstruction processing part 225 repeatedly executes a cycle of replacing the amplitude components of the complex amplitude distribution of the hologram image obtained from the result of propagation calculation with the actually measured amplitude component such that only the phase component remains.

Meanwhile, Maxwell's equations are reduced to a wave equation in a lossless, isotropic, and uniform medium. Further, each component of the electric field and the magnetic field satisfies a Helmholtz equation represented by the following expression (201) in monochromatic light that does not consider time evolution. In the following expression (201), g(x, y, z) represents a complex amplitude component of an electromagnetic vector component, and k represents a wave number represented by the following expression (203). “Propagation of the hologram image” according to this embodiment refers to a series of processing of using a boundary condition g(x, y, Z) (namely, complex amplitude component of hologram image on sensor surface S2) on the hologram image given for a specific plane (propagation source plane) to obtain a solution of the Helmholtz equation for another plane (support surface S1 in this embodiment). Such propagation processing is called “angular spectrum method” (plane wave expansion method).

$$\begin{matrix}[ Math . 3 ] & \\ ( Δ + {k}^{2} ) \cdot g ( x , y , z ) = 0 & expression ( 201 ) \\ k = \frac{2 π}{λ} & expression ( 203 )\end{matrix}$$

When a plane parallel to the propagation source is considered to be the support surface S1, and the solution of the Helmholtz equation on such a support surface S1 is set as g(x, y, 0), the exact solution is given by the following expression (205), which is also called “Rayleigh-Sommerfeld diffraction integral”. In the following expression (205), r′ is given by the following expression (207).

$$\begin{matrix} [ Math . 4 ] \\ & \\ g ( x , y , 0 ) = \int \int g ( {x}^{′} , {y}^{′} , {z}^{′} ) \frac{exp ( i 2 π {r}^{′} {λ}^{- 1} )}{{r}^{′}} \frac{z}{{r}^{′}} ( \frac{1}{2 π {r}^{′}} + \frac{1}{i λ} ) d {x}^{′} d {y}^{′} & expression ( 205 ) \\ {r}^{′} = \sqrt{{( x - {x}^{′} )}^{2} + {( y - {y}^{′} )}^{2} + {z}^{2}} & expression ( 207 )\end{matrix}$$

It takes time to calculate the integral form as shown in the above expression (205), and thus in this embodiment, an expression given by the following expression (209), which is obtained by Fourier-transforming both sides of the above expression (205), is adopted. In the following expression (209), G represents the Fourier transform of a complex amplitude component g, and F⁻¹ represents inverse Fourier transform. Further, u, v, w represent spatial frequency components in the x-direction, the y-direction, and the z-direction, respectively. In this case, u and v are associated with corresponding components of a wave number vector k=kₓ·x+k_{y}·y+k_{z}·z (x, y, z are unit vectors) and u=kₓ/2π and v=k_{y}/2π, whereas w is given by the following expression (211).

$$\begin{matrix}[ Math . 5 ] & \\ g ( x , y , 0 ) = {F}^{- 1} ( G ( u , v , z ) exp ( - i 2 π w ( u , v ) z ) ) & expression ( 209 ) \\ w ( u , v ) = \{ \begin{matrix}\sqrt{{λ}^{- 2} - {u}^{2} - {v}^{2}} & … & {u}^{2} + {v}^{2} \leq {λ}^{- 2} \\ 0 & … & otherwise\end{matrix} & expression ( 211 )\end{matrix}$$

As described later, the reconstruction processing part 225 according to this embodiment uses the complex amplitude distribution of the hologram propagated from the support surface S2 to the support surface S1 at a predetermined wavelength to recalculate the complex amplitude distribution of the hologram to be propagated from the support surface S1 to the sensor surface S2 at a wavelength different from the above-mentioned wavelength. Thus, in this embodiment, the following expression (213), which is replaces the above expression (209), is adopted.

[Math. 6]

g_{λ2}(x,y,z)=F⁻¹{G_{λ1}(u,v,z)exp[−i2π(w₂(u,v)−w₁(u,v))z]} expression (213)

The above expression (213) means using the complex amplitude distribution of the hologram g_{λ1} propagated from the sensor surface S2 to the support surface S1 at the wavelength λ₁ to calculate the complex amplitude distribution of the hologram g_{λ2} to be propagated from the support surface S1 to the sensor surface S2 at the wavelength λ₂.

In this embodiment, the reconstruction calculation part 225A repeatedly calculates optical wave propagation between the sensor surface S2 and the support surface S1 based on propagation calculation expressions of the above expressions (209) and (213). For example, when the amplitude replacement part 225B does not execute amplitude replacement on the support surface S1 as described later, the reconstruction calculation part 225A executes propagation calculation based on the expression (213). On the contrary, when the amplitude replacement part 225B executes amplitude replacement, the amplitude replacement part 225B replaces the amplitude components of the complex amplitude distribution of the hologram g_{λ1} propagated from the sensor surface S2 to the support surface S1 at the wavelength λ₁ with a predetermined amplitude representative value based on the above expression (209), and calculates the complex amplitude distribution of the hologram g_{λ2} to be propagated from the support surface S1 to the sensor surface S2 at the wavelength λ₂.

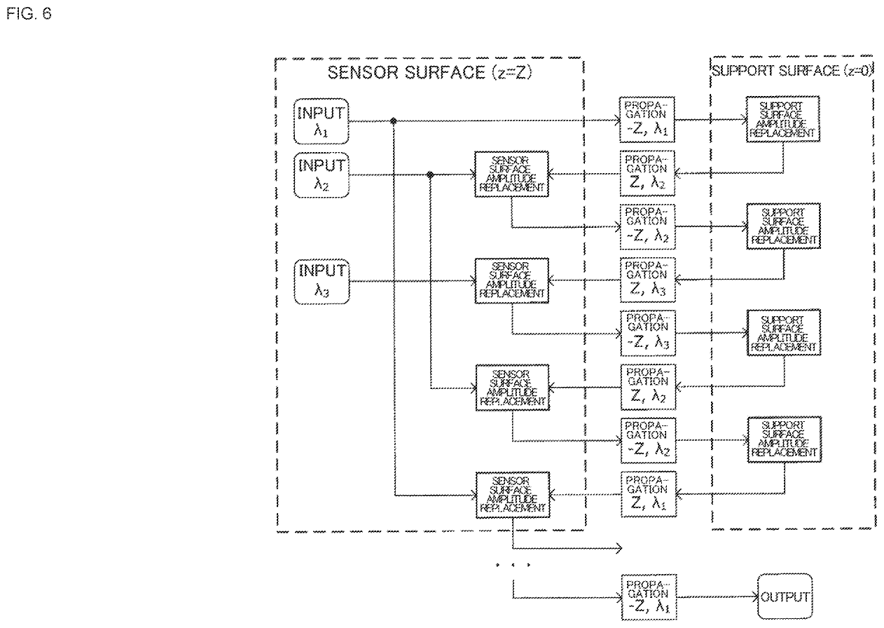

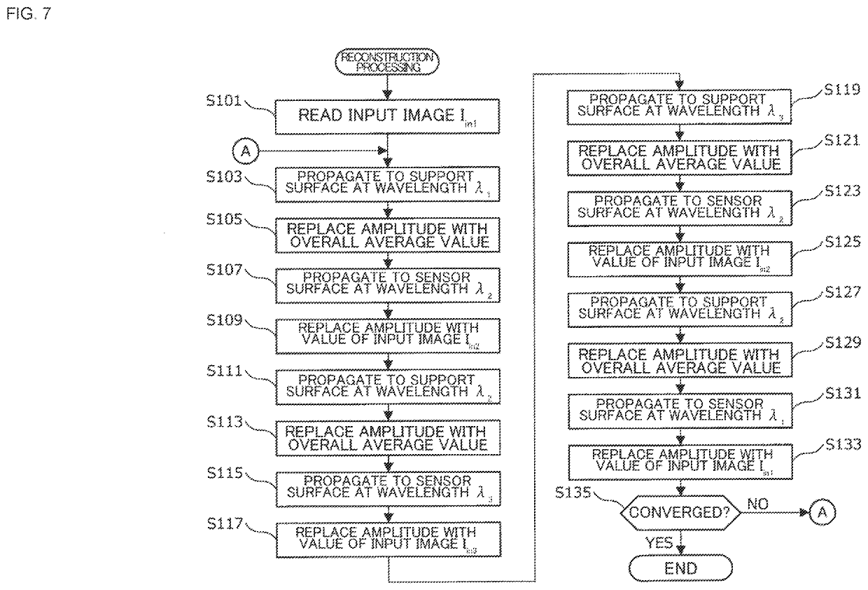

In the following, specific description is given of a series of propagation calculation processing to be executed by the reconstruction processing part 225 with reference to FIG. 6 and FIG. 7.

First, among preprocessed images output from the preprocessing part 223, an input image Iᵢₙ₁ is read (Step S101), and the reconstruction calculation part 225A executes first optical wave propagation calculation of propagating the complex amplitude distribution (light intensity distribution) of the hologram image g_{λ1} from the sensor surface S2 to the support surface S1 (Step S103). The complex amplitude distribution of the hologram image g_{λ1} output from the preprocessing part 223 is represented by the following expression (221), and the complex amplitude distribution of the hologram image g_{λ1} propagated to the support surface S1 is represented by the following expression (223).

The complex amplitude distribution of the hologram g_{λ1} represented by the following expression (223) is the complex amplitude distribution of the hologram image g_{λ1} obtained as a result of the above-mentioned first optical wave propagation calculation. The complex amplitude distribution of the hologram image in this embodiment is the complex amplitude distribution of light forming the hologram, and has the same meaning in the following description.

Further, in the following expression (221), a(x, y, z) represents the amplitude component, and exp(iφ(x, y, z)) represents the phase component (set initial value). Similarly, in the following expression (223), A′(x, y, 0) represents the amplitude component, and exp(iφ′(x, y, 0)) represents the phase component.

g_{λ1}(x,y,z)=A(x,y,z)exp(iφ(x,y,z)) expression (221)

g_{λ1}(x,y,0)=A′(x,y,0)exp(iφ′(x,y,0)) expression (223)

Next, the amplitude replacement part 225B extracts the amplitude components A′ of the complex amplitude distribution of the hologram image g_{λ1} propagated to the support surface S1 at the wavelength a λ₁, and calculates an average value Aₐᵥₑ of the amplitude components A′. Then, the amplitude replacement part 225B replaces the amplitude components A′ of the complex amplitude distribution of the hologram image g_{λ1} with the average value Aₐᵥₑ on the support surface S1 as one procedure of second optical wave propagation calculation described later (Step S105).

As a result, the amplitude component of the complex amplitude distribution of the hologram image g_{λ1} is smoothed, and a calculation load in the subsequent repetition processing is reduced. The hologram image g_{λ1} for which the amplitude components A′ are replaced with the average value Aₐᵥₑ is represented by the following expression (225). Further, the average value Aₐᵥₑ after replacement is represented by the following expression (227). A parameter N in the following expression (227) is the total number of pixels.

g_{λ1}(x,y,0)=Aₐᵥₑ·exp(iφ′(x,y,0)) expression (225)

Aₐᵥₑ=1/N(ΣΣA′(x,y,0)) expression (227)

The average value Aₐᵥₑ according to this embodiment is typically an average value of the amplitude components A′ in the complex amplitude distribution (expression (223)) obtained as a result of the above-mentioned first optical wave propagation calculation. Such an average value can be set to be a proportion (cumulative average) of the total sum of amplitude components corresponding to the respective pixels of the hologram image g_{λ1}(x, y, 0) to the number N of pixels of the hologram image g_{λ1} (x, y, 0).

Further, in the above-mentioned example, the amplitude components A′ are replaced with the average value Aₐᵥₑ. Instead, a predetermined amplitude representative value of the amplitude components A′ of the complex amplitude distribution (expression (223)) of the hologram image g_{λ1} can also be used. For example, the amplitude replacement part 225B may replace the amplitude components A′ with a median of the amplitude components A′ other than the average value Aₐᵥₑ, or may replace the amplitude components A′ with a low-pass filter transmission component of the amplitude components A′.

Next, the reconstruction calculation part 225A executes the second optical wave propagation calculation of propagating the complex amplitude distribution of the hologram image g_{λ1} for which the amplitude components A′ are replaced with the average value Aₐᵥₑ from the support surface S1 to the sensor surface S2 at the wavelength λ₂ (Step S107). In other words, the complex amplitude distribution of the hologram g_{λ2} to be propagated from the complex amplitude distribution of the hologram image g_{λ1} represented by the above expression (225) to the sensor surface S2 at the wavelength λ₂ is obtained by propagation calculation. Such a complex amplitude distribution of the hologram image g_{λ2} is represented by the following expression (229).

g_{λ2}(x,y,z)=A″(x,y,z)exp(iφ″(x,y,z)) expression (229)

Next, the amplitude replacement part 225B replaces the amplitude components A″ of the complex amplitude distribution of the hologram image g_{λ2} propagated at the wavelength λ₂ with actually measured values A_{λ2} of the amplitude components A″ on the sensor surface S2 as one procedure of the above-mentioned first optical wave propagation calculation (Step S109). Those actually measured values A_{λ2} are amplitude components extracted from the hologram image g_{λ2} acquired as an input image Iᵢₙ₂.

The hologram image g_{λ2} for which the amplitude components A″ are replaced with the actually measured values A_{λ2} on the sensor surface S2 is represented by the following expression (231). As a result, it is possible to obtain the hologram image g_{λ2} having a phase component. In the following expression (231), A_{λ2}(x, y, z) represents the amplitude component, and exp(iφ″ (x, y, z)) represents the reproduced phase component.

g_{λ2}(x,y,z)=A_{λ2}(x,y,z)exp(iφ″(x,y,z)) expression (231)

In this manner, the reconstruction processing part 225 executes the first light propagation calculation of propagating the complex amplitude distribution having the light intensity distribution of the hologram image of the observation target object C acquired on the sensor surface S2 from the sensor surface S2 to the support surface S1, and executes the cycle of the second light propagation calculation of propagating the complex amplitude distribution obtained as a result of the first light propagation calculation from the support surface S1 to the sensor surface S2.

In this embodiment, as illustrated in FIG. 6 and FIG. 7, such a cycle is executed for all the hologram images g_{λ1}, g_{λ2}, g_{λ3} in order (Step S111 to Step S133). In this manner, the phase component that has not been recorded by the image sensor 13 for three types of hologram images g_{λ1}, g_{λ2}, g_{λ3} is reproduced by the above-mentioned propagation calculation.

Next, the reconstruction calculation part 225A determines whether the above-mentioned propagation calculation has converged (Step S135). A specific technique of convergence determination is not particularly limited, and various kinds of publicly known techniques can be used. When the reconstruction calculation part 225A has determined that a series of calculation processing for reproducing the phase have not converged (Step S135-NO), the reconstruction calculation part 225A returns to Step S103 to restart a series of calculation processing for reproducing the phase. On the contrary, when the reconstruction calculation part 225A has determined that a series of calculation processing for reproducing the phase have converged (Step S135—YES), as illustrated in FIG. 6, the reconstruction calculation part 225A lastly propagates the obtained complex amplitude distribution of the hologram image to the support surface S1 to obtain the reconstructed image of the observation target object C, and then outputs the obtained reconstructed image.

In the above description, a time point at which the series of calculation processing for reproducing the phase are finished is determined by convergence determination, but in this embodiment, not the above-mentioned convergence determination but whether or not the series of calculation as described above have been executed a defined number of times may be used to determine the time point at which the series of calculation processing are finished. In this case, the number of times of repeating calculation is not particularly limited, but it is preferred to set the number of times to about ten to one hundred, for example.

Further, when the reconstruction calculation part 225A obtains a reconstructed image, the reconstruction calculation part 225A can obtain the amplified image of the focused observation target object C by calculating Re²+Im² through use of a real part (Re) and an imaginary part (Im) of the complex amplitude distribution obtained last, and can obtain the phase image of the focused observation target object C by calculating A tan(Im/Re).

FIG. 6 and FIG. 7 focus on a case in which the propagation wavelength is used in order of λ₁→λ₂→λ₂→λ₃→λ₃→λ₂→λ₂→λ₁→λ₁ in propagation of the hologram image repeated between the sensor surface S2 and the support surface S1. However, the order of the propagation wavelength is not limited to the example illustrated in FIG. 6 and FIG. 7, and is indefinite. For example, the reconstruction processing part 225 may select the propagation wavelength in order of λ₁→λ₃→λ₃→λ₂→λ₂→λ₃→λ₃→λ₁→λ₁, or may set the propagation wavelength in order of λ₃→λ₁→λ₁→λ₂→λ₂→λ₂→λ₁→λ₁→λ₃→λ₃, for example. Further, a reconstructed image can be obtained similarly to the above description also when the light source part 11 is constructed by the two LEDs 101 or when the light source part 11 is constructed by the four or more LEDs 101.

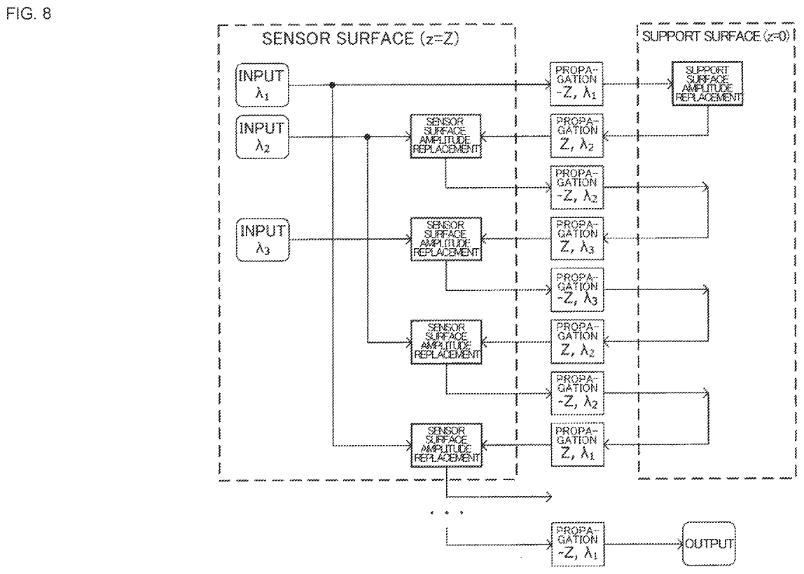

In FIG. 6 and FIG. 7, description has been given of a case in which the reconstruction calculation part 225A executes amplitude replacement processing on the support surface S1 every time repetition processing for reproducing the phase is executed. However, as illustrated in FIG. 8, an operation for replacing the amplitude on the support surface S1 may be executed only once within a series of loop processing.

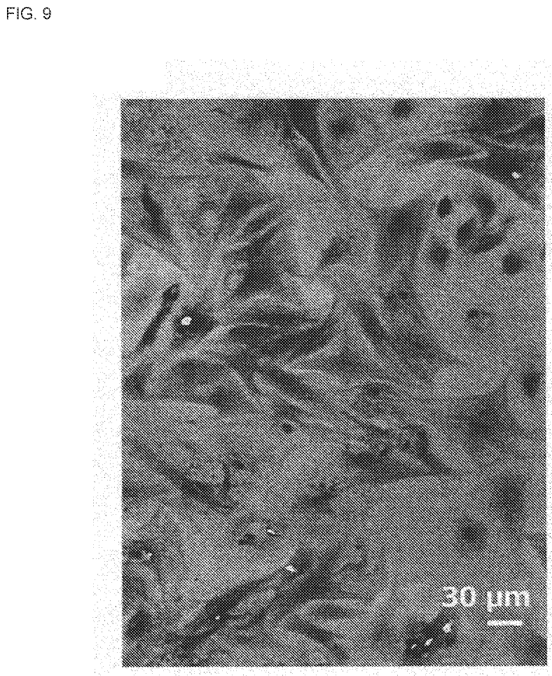

The series of processing as described above is executed to enable the reconstruction processing part 225 to calculate the amplified image and phase image of the focused observation target object C. An example of the phase image of the observation target object obtained in this manner is illustrated in FIG. 9. FIG. 9 represents an example of observing a cardiac muscle cell by the observation device 1 according to this embodiment, and it is understood that the image of the cardiac muscle cell is obtained satisfactorily.

In the above, the configuration of the image calculation part 205 according to this embodiment has been described in detail.

In the above, an example of the function of the calculation processing part 20 according to this embodiment has been described. Each component described above may be constructed by using a general-purpose part or circuit, or may be constructed by hardware dedicated to the function of each component. Further, a CPU or the like may execute all the functions of each component. Thus, the configuration to be used can be changed appropriately depending on the technological level at the time of carrying out this embodiment.

A computer program for realizing each function of the calculation processing part according to this embodiment as described above can be created, and implemented on a personal computer, for example. Further, a computer-readable recording medium having stored thereon such a computer program can also be provided. The recording medium is, for example, a magnetic disk, an optical disc, a magneto-optical disk, or a flash memory. Further, the above-mentioned program may be distributed via a network or the like without using a recording medium.

Hardware Configuration of Calculation Processing Part

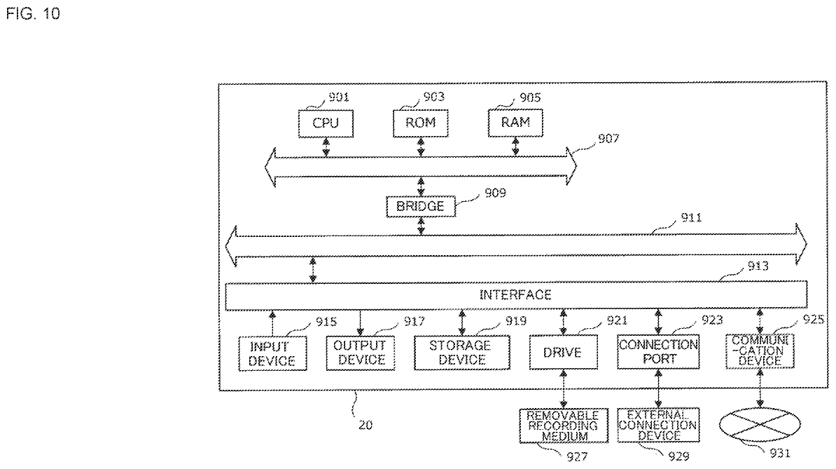

Next, description is given in detail of the hardware configuration of the calculation processing part 20 according to an embodiment of the present disclosure with reference to FIG. 10. FIG. 10 is a block diagram for describing the hardware configuration of the calculation processing part 20 according to an embodiment of the present disclosure.

The calculation processing part 20 mainly includes a CPU 901, a ROM 903, and a RAM 905. The calculation processing part 20 further includes a host bus 907, a bridge 909, an external bus 911, an interface 913, an input device 915, an output device 917, a storage device 919, a drive 921, a connection port 923, and a communication device 925.

The CPU 901 functions as a calculation processing device and a control device, and controls an entire or part of operation of the calculation processing part 20 in accordance with various kinds of programs recorded in the ROM 903, the RAM 905, the storage device 919, or a removable recording medium 927. The ROM 903 stores a program, a calculation parameter, or other information to be used by the CPU 901. The RAM 905 temporarily stores, for example, the program to be used by the CPU 901 or a parameter that changes as appropriate through execution of the program. Those components are connected to one another via the host bus 907 constructed by an internal bus such as a CPU bus.

The host bus 907 is connected to the external bus 911 such as a peripheral component interconnect/interface (PCI) bus via the bridge 909.

The input device 915 is operation means to be operated by the user, such as a mouse, a keyboard, a touch panel, a button, a switch, or a lever. Further, the input device 915 may be, for example, remote control means (so-called remote controller) that uses an infrared ray or other radio waves, or may be an external connection device 929 such as a mobile phone or PDA that supports operation of the calculation processing part 20. Further, the input device 915 is constructed by, for example, an input control circuit for generating an input signal based on information input by the user using the above-mentioned operation means, and outputting the generated input signal to the CPU 901. The user can input various kinds of data to the calculation processing part 20 or instruct the calculation processing part 20 to execute a processing operation by operating the input device 915.

The output device 917 is constructed by a device that can notify the user of acquired information visually or aurally. Such a device includes a display device such as a CRT display device, a liquid crystal display device, a plasma display device, an EL display device, or a lamp, a sound output device such as a speaker or headphones, a printer device, a mobile phone, or a facsimile. The output device 917 outputs, for example, a result obtained by various kinds of processing executed by the calculation processing part 20. Specifically, the display device displays the result obtained by various kinds of processing executed by the calculation processing part 20 as text or an image. Meanwhile, the sound output device converts an audio signal including, for example, reproduced sound data or acoustic data into an analog signal, and outputs the analog signal.

The storage device 919 is a device for storing data constructed as an example of a storage part of the calculation processing part 20. The storage device 919 is constructed by, for example, a magnetic storage device such as a hard disk drive, a semiconductor storage device, an optical storage device, or a magneto-optical storage device. This storage device 919 stores, for example, a program to be executed by the CPU 901, various kinds of data, and various kinds of data acquired from the outside.

The drive 921 is a reader or writer for a recording medium, and is incorporated in the calculation processing part 20 or externally attached to the calculation processing part 20. The drive 921 reads information recorded in the set removable recording medium 927 such as a magnetic disk, an optical disc, a magneto-optical disk, or a semiconductor memory, and outputs the information to the RAM 905. Further, the drive 921 can also write information into the set removable recording medium 927 such as a magnetic disk, an optical disc, a magneto-optical disk, or a semiconductor memory. The removable recording medium 927 is, for example, DVD media, HD-DVD media, or Blu-ray (registered trademark) media. Further, the removable recording medium 927 may be, for example, CompactFlash (CF) (registered trademark), a flash memory, or a secure digital (SD) memory card. Further, the removable recording medium 927 may be, for example, an integrated circuit (IC) card or an electronic device having mounted thereon a non-contact IC chip.

The connection port 923 is a port for directly connecting a device to the calculation processing part 20. An example of the connection port 923 is a universal serial bus (USB) port, an IEEE 1394 port, or a small computer system interface (SCSI) port. Another example of the connection port 923 is an RS-232C port, an optical audio terminal, or a high-definition multimedia interface (HDMI) (registered trademark). The external connection device 929 is connected to the connection port 923 so as to cause the calculation processing part 20 to directly acquire various kinds of data from the external connection device 929, or provide the external connection device 929 with various kinds of data.

The communication device 925 is, for example, a communication interface constructed by a communication device or the like for connecting to a communication network 931. The communication device 925 is, for example, a communication card or the like for a wired or wireless local area network (LAN), Bluetooth (registered trademark), or Wireless USB (WUSB). Further, the communication device 925 may be, for example, a router for optical communication, a router for asymmetric digital subscriber line (ADSL), or a modem for various kinds of communication. This communication device 925 can transmit/receive, for example, a signal or the like to/from, for example, the Internet or other communication devices in accordance with a predetermined protocol such as TCP/IP. Further, the communication network 931 to be connected to the communication device 925 is constructed by, for example, a network connected in a wired or wireless manner, and may be, for example, the Internet, a domestic LAN, infrared communication, radio communication, or satellite communication.

In the above, an example of the hardware configuration that can realize the function of the calculation processing part 20 according to an embodiment of the present disclosure has been described. Each component described above may be constructed by using a general-purpose member or by hardware dedicated to the function of each component. Thus, the configuration to be used can be changed appropriately depending on the technological level at the time of carrying out this embodiment.

### <Regarding Observation Method>

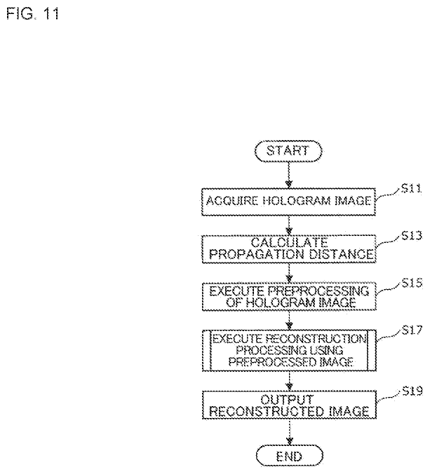

Next, description is given briefly of a flow of a method of observing an observation target object by using the observation device 1 as described above with reference to FIG. 11. FIG. 11 is a flow chart illustrating an example of the flow of the observation method according to this embodiment.

As illustrated in FIG. 11, in the observation method according to this embodiment, the hologram acquisition part 10 of the observation device 1 first acquires a hologram image of a focused observation target object for each light emission wavelength of illumination light applied by the light source part 11 under control by the calculation processing part 20 (Step S11). The acquired hologram image is output to the calculation processing part 20 of the observation device 1.

Next, the propagation distance calculation part 221 included in the calculation processing part 20 of the observation device 1 uses the acquired hologram image to calculate the propagation distance z (Step S13), and outputs the obtained result to the preprocessing part 223 and the reconstruction processing part 225. After that, the preprocessing part 223 uses the obtained hologram image and the propagation distance calculated by the propagation distance calculation part 221 to execute the series of preprocessing as described above (Step S15). Shift correction of an image based on the position of the LED is performed in such preprocessing, so that the observation method according to this embodiment can suppress with a simpler method distortion that may occur in an inline hologram when a plurality of lights having different wavelengths are used.

After that, the reconstruction processing part 225 uses the hologram image after preprocessing (preprocessed image) to execute the series of reconstruction processing as described above (Step S17). As a result, the reconstruction processing part 225 can obtain a reconstructed image (amplified image and phase image) of the focused observation target object. After the reconstruction processing part 225 calculates the reconstructed image of the focused observation target object, the reconstruction processing part 225 outputs image data of such a reconstructed image to the output control part 207.

The output control part 207 outputs the reconstructed image output from the reconstruction processing part 225 by a method specified by the user, for example, and presents the reconstructed image to the user (Step S19). As a result, the user can observe the focused observation target object.

In the above, the observation method according to this embodiment has been described briefly with reference to FIG. 11.

In this manner, the observation device and observation method according to this embodiment provide a device that can satisfactorily observe a transparent phase object such as a cell by the hologram acquisition part constructed by an extremely small number of parts such as LEDs, an image sensor and a bandpass filter. Such a device is downsized extremely easily, and thus it is possible to arrange an observation device also in a region in which a microscope has not hitherto been able to be installed, such as an inside of a bioreactor. As a result, it is possible to obtain a phase image of a biomaterial such as a cell in a simpler manner.

Further, the observation device according to this embodiment does not waste light due to the space aperture or the like, and thus it is possible to realize an observation device including a highly efficient light source with low power consumption. Further, it is not necessary to execute complicated preprocessing by using adjacent micro LEDs having different wavelengths, which can simplify and speed up processing.

### Embodiment Example

In the following, description is given briefly of the observation device and observation method according to an embodiment of the present disclosure with reference to specific images. In the example given below, an observation device having the configuration as illustrated in FIG. 1B and FIG. 2A was used to observe a part of a commercially available resolution test chart. Further, for comparison, the case of using a device in which the light source part of the observation device was replaced with a generally used LED and a conventional lensless microscope (lensless microscope that uses both of optical fiber and pinhole) was observed similarly.

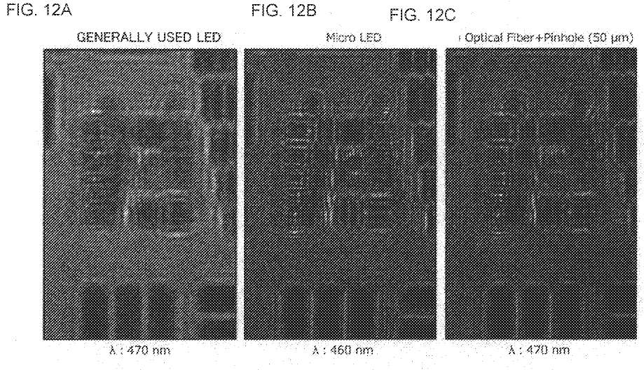

The obtained results are both shown in FIG. 12.

As can be clearly understood from comparison between FIG. 12(b) and FIG. 12(c), the observation device according to an embodiment of the present disclosure exhibited satisfactory interference fringes, and an extremely high frequency contrast was observed, that is, an image of an equivalent quality as that of the conventional method was obtained.

Meanwhile, as can be clearly understood from comparison between FIG. 12(a) and FIG. 12(b), when a generally used LED was used as a light source, interference fringes were observed, but the contrast was overall low.

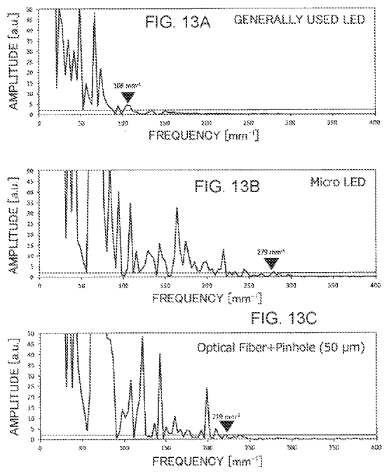

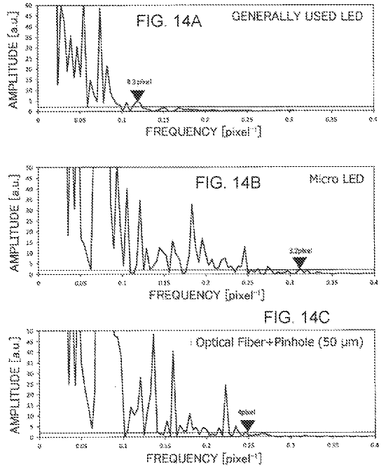

In order to compare the results shown in FIG. 12(a) to FIG. 12(c) more clearly, each image shown in FIG. 12(a) to FIG. (c) was Fourier-transformed to obtain an FFT spectrum, and the frequency characteristics of the recorded inline holograms were compared. The obtained results were shown in FIG. 13(a) to FIG. 14(c). FIG. 13(a) to FIG. 13(c) show FFT spectrums based on the length unit system, and the unit of the horizontal axis is [mm⁻¹]. FIG. 14(a) to FIG. 14(c) show FFT spectrums based on the pixel unit system, and the unit of the horizontal axis is [pixel].

When frequencies producing the same amplitude were compared in FIG. 13(a) to FIG. 13(c) and FIG. 14(a) to FIG. 14(c), and a generally used LED shown in FIG. 13(a) and FIG. 14(a) was used as a coherence light source, the frequency was 108 mm⁻¹ (0.12 pixel⁻¹). The frequency of 0.12 pixel⁻¹ is a frequency that produces interference fringes of an 8.3 pixel width.

Meanwhile, when the observation device according to an embodiment of the present disclosure illustrated in FIG. 13(b) and FIG. 14(b) was used, the frequency was 279 mm⁻¹ (0.31 pixel⁻¹). The frequency of 0.31 pixel⁻¹ is a frequency that produces interference fringes of a 3.2 pixel⁻¹ width. Further, when a conventional coherence light source illustrated in FIG. 13(c) and FIG. 14(c) was used, the frequency was 219 mm⁻¹ (0.25 pixel⁻¹). The frequency of 0.25 pixel⁻¹ is a frequency that produces interference fringes of a 4.0 pixel width.

As can be clearly understood from those results, when the observation device according to an embodiment of the present disclosure is used, a finer frequency component is included than in the case of using a generally used LED as the coherence light source. Further, it is also understood that the observation device according to an embodiment of the present disclosure records a finer frequency component than that of the conventional method. Such a result indicates the fact that the observation device according to an embodiment of the present disclosure successfully records an inline hologram (in other words, interference of higher frequency) more accurate than that of the conventional method. This result is estimated to be caused because the light source part of the observation device according to an embodiment of the present disclosure had a smaller light emission point than that of the pinhole of the conventional method.

In the above, a preferred embodiment of the present disclosure has been described in detail with reference to the attached drawings. However, the technical scope of the present disclosure is not limited to such an example. It is clear that a person skilled in the art of the present disclosure could arrive at various kinds of change examples or modification examples within the technical idea described in the appended claims. It is understood that those change examples or modification examples also naturally fall within the technical scope of the present disclosure.

Further, an effect described in this specification is given just for explanation or as an example, and is not given in a limited manner. That is, in addition to or instead of the above-mentioned effect, the technology according to the present disclosure could exhibit other effects that are apparent for a person skilled in the art based on the description of this specification.

The following configuration also falls within the technical scope of the present disclosure.

(1)

An observation device including:

a light source part in which a plurality of light emitting diodes having different light emission wavelengths with a length of each light emission point being smaller than 100λ (λ: light emission wavelength) are arranged such that a separation distance between the adjacent light emitting diodes is equal to or smaller than 100λ (λ: light emission wavelength); and

an image sensor installed so as to be opposed to the light source part with respect to an observation target object.

(2)

The observation device according to (1), in which a length of the separation distance is equal to or smaller than five times the length of the light emission point.

(3)

The observation device according to (1) or (2), in which a bandpass filter setting a transmission wavelength band to a peak wavelength of each of the plurality of light emitting diodes is installed between the observation target object and the light source part

(4)

The observation device according to any one of (1) to (3), further including a calculation processing part for executing calculation processing for obtaining an image of the observation target object by using a photographed image for each light emission wavelength, the photographed image being generated by the image sensor, in which

the calculation processing part includes:

a preprocessing part for executing, for the photographed image for each light emission wavelength, preprocessing including at least shift correction of the image that depends on a positional relationship among the plurality of light emitting diodes; and

a reconstruction processing part for reconstructing the image of the observation target object by using the preprocessed photographed image.

(5)

The observation device according to (4), in which the preprocessing part is configured to execute the shift correction so as to cancel a positional deviation between the photographed images due to positions at which the respective light emitting diodes are installed.

(6)

The observation device according to (4) or (5), in which the preprocessing part is configured to:

select one light emitting diode serving as a reference from among the plurality of light emitting diodes; and shift spatial coordinates of the photographed images which are photographed by using the remaining light emitting diodes other than the light emitting diode serving as the reference, in a direction of the photographed image which is photographed by using the light emitting diode serving as the reference, among the plurality of light emitting diodes.

(7)

The observation device according to any one of (4) to (6), in which

the light source part includes the three light emitting diodes having different light emission wavelengths arranged in one row, and

the preprocessing part is configured to shift spatial coordinates of the photographed images which are photographed by using the light emitting diodes positioned at both ends, in a direction of the photographed image which is photographed by using the light emitting diode positioned at a center by a correction amount δ calculated by the following expression (1).

(8)

The observation device according to any one of (4) to (6), in which

the light source part includes the three light emitting diodes having different light emission wavelengths arranged in a triangle, and

the preprocessing part is configured to shift spatial coordinates of the photographed images which are photographed by using any two of the light emitting diodes, in a direction of the photographed image which is photographed by using the one remaining light emitting diode.

(9)

The observation device according to any one of (1) to (8), in which the observation target object is a biomaterial.

(10)

An observation method including:

applying light to an observation target object for each light emission wavelength by a light source part in which a plurality of light emitting diodes having different light emission wavelengths with a length of each light emission point being smaller than 100λ (λ: light emission wavelength) are arranged such that a separation distance between the adjacent light emitting diodes is equal to or smaller than 100λ (λ: light emission wavelength); and

photographing an image of the observation target object for each light emission wavelength by an image sensor installed so as to be opposed to the light source part with respect to the observation target object.

(11)

An observation system including:

a light source part in which a plurality of light emitting diodes having different light emission wavelengths with a length of each light emission point being smaller than 100λ (λ: light emission wavelength) are arranged such that a separation distance between the adjacent light emitting diodes is equal to or smaller than 100λ (λ: light emission wavelength);

an image sensor installed so as to be opposed to the light source part with respect to an observation target object; and

a calculation processing part for executing calculation processing of obtaining an image of the observation target object by using a photographed image for each light emission wavelength which is generated by the image sensor.

$$\begin{matrix}[ Math . 7 ] & \\ δ = \frac{p Z}{L - Z} & expression ( 1 )\end{matrix}$$

In the above expression (1), δ represents a correction amount, L represents a distance between the light source part and the image sensor, Z represents a distance between the observation target object and the image sensor, and p represents a distance between the light emitting diodes.

### REFERENCE SIGNS LIST

1 Observation device
10 Hologram acquisition part
11 Light source part
13 Image sensor
15 Bandpass filter
20 Calculation processing part
101 Light emitting diode
201 Hologram acquisition control part
203 Data acquisition part
205 Image calculation part
207 Output control part
209 Display control part
211 Storage part
221 Propagation distance calculation part
223 Preprocessing part
225 Reconstruction processing part
225A Reconstruction calculation part
225B Amplitude replacement part
231 Gradation correction part
233 Upsampling part
235 Image shift part
237 Image end processing part
239 Initial complex amplitude generation part

1. An observation device comprising:
a light source part in which a plurality of light emitting diodes having different light emission wavelengths with a length of each light emission point being smaller than 100λ (λ: light emission wavelength) are arranged such that a separation distance between the adjacent light emitting diodes is equal to or smaller than 100λ (λ: light emission wavelength); and
an image sensor installed so as to be opposed to the light source part with respect to an observation target object.

2. The observation device according to claim 1, wherein a length of the separation distance is equal to or smaller than five times the length of the light emission point.

3. The observation device according to claim 1, wherein a bandpass filter setting a transmission wavelength band to a peak wavelength of each of the plurality of light emitting diodes is installed between the observation target object and the light source part.

4. The observation device according to claim 1, further comprising a calculation processing part for executing calculation processing for obtaining an image of the observation target object by using a photographed image for each light emission wavelength, the photographed image being generated by the image sensor, wherein the calculation processing part comprises:
a preprocessing part for executing, for the photographed image for each light emission wavelength, preprocessing including at least shift correction of the image that depends on a positional relationship among the plurality of light emitting diodes; and
a reconstruction processing part for reconstructing the image of the observation target object by using the preprocessed photographed image.

5. The observation device according to claim 4, wherein the preprocessing part is configured to execute the shift correction so as to cancel a positional deviation between the photographed images due to positions at which the respective light emitting diodes are installed.

6. The observation device according to claim 4, wherein the preprocessing part is configured to:
select one light emitting diode serving as a reference from among the plurality of light emitting diodes; and
shift spatial coordinates of the photographed images which are photographed by using the remaining light emitting diodes other than the light emitting diode serving as the reference in a direction of the photographed image which is photographed by using the light emitting diode serving as the reference among the plurality of light emitting diodes.

7. The observation device according to claim 4, wherein
the light source part includes the three light emitting diodes having different light emission wavelengths arranged in one row, and
the preprocessing part is configured to shift spatial coordinates of the photographed images which are photographed by using the light emitting diodes positioned at both ends in a direction of the photographed image which is photographed by using the light emitting diode positioned at a center by a correction amount δ calculated by the following expression (1):
$$\begin{matrix}[ Math . 1 ] & \\ δ = \frac{p Z}{L - Z} & expression ( 1 )\end{matrix}$$
where, in the expression (1), δ represents a correction amount, L represents a distance between the light source part and the image sensor, Z represents a distance between the observation target object and the image sensor, and p represents a distance between the light emitting diodes.

8. The observation device according to claim 4, wherein
the light source part includes the three light emitting diodes having different light emission wavelengths arranged in a triangle, and
the preprocessing part is configured to shift spatial coordinates of the photographed images which are photographed by using any two of the light emitting diodes in a direction of the photographed image which is photographed by using the one remaining light emitting diode.

9. The observation device according to claim 1, wherein the observation target object is a biomaterial.

10. An observation method comprising:
applying light to an observation target object for each light emission wavelength by a light source part in which a plurality of light emitting diodes having different light emission wavelengths with a length of each light emission point being smaller than 100λ (λ: light emission wavelength) are arranged such that a separation distance between the adjacent light emitting diodes is equal to or smaller than 100λ (λ: light emission wavelength); and
photographing an image of the observation target object for each light emission wavelength by an image sensor installed so as to be opposed to the light source part with respect to the observation target object.

11. An observation system comprising:
a light source part in which a plurality of light emitting diodes having different light emission wavelengths with a length of each light emission point being smaller than 100λ (λ: light emission wavelength) are arranged such that a separation distance between the adjacent light emitting diodes is equal to or smaller than 100λ (λ: light emission wavelength);
an image sensor installed so as to be opposed to the light source part with respect to an observation target object; and
a calculation processing part for executing calculation processing of obtaining an image of the observation target object by using a photographed image for each light emission wavelength which is generated by the image sensor.
